(19) United States
(12) Patent Application Publication
(10) Pub. No.: US 2006/0140421 A1
(43) Pub. Date: Jun. 29, 2006

(54) Sound fishing lure and method for using

(76) Inventor: James Swafford, Medina, TN (US)

Correspondence Address: John R. Ross, III;Ross Patent Law Office, P.O. Box 2138, Del Mar, CA, 92014, US

(21) Appl. No.: 11/022,602

(22) Filed: Dec. 27, 2004

(51) Int. Cl. A01K 29/00; A01K 15/02; A01K 15/04; A01K 71/00; G09F 27/00; A01K 79/00

(52) U.S. Cl. 381/124; 119/174; 119/719; 43/4.5

(57) ABSTRACT

A sound fishing lure with a speaker system. A power source provides power to an integrated circuit chip programmed to produce electronic signals that when transmitted to the speaker produce animal sounds. Fish hearing the sounds are attracted to the fishing lure. In a preferred embodiment, the chip is programmed to record and playback actual animal sounds. In another preferred embodiment, the recorded sound is that of a pigfish grunting.

### BACKGROUND OF THE INVENTION

### Pigfish (Orthopristis chrysoptera)

Pigfish are popular baitfish that can grow to a length of 12 to 15 inches. Pigfish are common on the South Atlantic and Gulf coasts of the United States. The range is north to Long Island and south to the mouth of the Rio Grande River. Pigfish are particularly abundant along the Carolina coast.

Pigfish are members of the grunt family (Haenulidae) which are noted for the rasping or grunting sounds they make in their throat when captured on a hook or otherwise disturbed. The grunt resembles the sound made by a pig and is produced by means of a pair of movable muscles in the throat covered with small recurved teeth, known as pharyngeal teeth.

Fishermen have very good results using pigfish as bait to catch saltwater Seatrout as well as other larger fish. Fishermen will testify that the grunting sound made by Pigfish seems to attract the catch very effectively. Applicant notes that on a recent fishing trip he observed a fisherman bait his hook with a live pigfish that was grunting. After only two minutes of being in the water, the fisherman caught a six pound saltwater Seatrout.

Unfortunately, however, a pigfish does not live very long while baited. Once it dies, its ability to grunt is gone and it loses much of its unique effectiveness as bait.

### Small Lightweight Sound Recording and Playback Device

FIGS. 2-3 show a prior art portable small, lightweight sound recording and playback device 2. Recording and playback devices similar to recording and playback device 2 are available from Voice-Express Corporation with offices in Westport, Conn. As shown in FIG. 1, four batteries 3 are mounted on printed circuit board (PCB) 1 and provide power to programmable playback/record integrated circuit chip 4. Playback/Record/Off switch 7 is also mounted to PCB 1. PCB 1 is mounted inside aluminum casing 8. A top view of casing 8 is shown in FIG. 2 and a side view is shown in FIG. 3. Aluminum casing 8 is approximately 1¾ inch in diameter and has a cutout section to allow access to switch 7. Small holes 9 are in the top of casing 8 to allow sound to travel to microphone 5 and sound to travel from speaker 6.

Sound recording and playback device 2 is commonly placed in a child's toy such as child's toy 11, as shown in FIG. 4. A child can record a message onto playback/record chip 4 by moving switch 7 to “record”. Digital data representative of the child's message is stored on chip 4. When switch 7 is moved to “play” electrical signals representative of the child's message is transmitted from chip 4 to speaker 6 where the speaker converts the electrical signals to sound for the child to hear. Sound recording and playback device 2 is capable of recording a 20 second message. Chip 4 is programmed to repeat the message until switch 7 is moved to “off”.

### Speakers

Speakers are known in the prior art and are electro-acoustic transducers that convert electrical signals into sounds loud enough to be heard at a distance.

### Underwater Speakers

Waterproof underwater speakers are known. For example, synchronized swimmers will perform to music being played through underwater speakers mounted under the waterline on the side of a pool. Also, deep sea divers can communicate through underwater telephones that utilize underwater speakers to transmit sound.

What is needed is a better fishing lure.

### SUMMARY OF THE INVENTION

The present invention provides a sound fishing lure with a speaker system. A power source provides power to an integrated circuit chip programmed to produce electronic signals that when transmitted to the speaker produce animal sounds. Fish hearing the sounds are attracted to the fishing lure. In a preferred embodiment, the chip is programmed to record and playback actual animal sounds. In another preferred embodiment, the recorded sound is that of a pigfish grunting.

### BRIEF DESCRIPTION OF THE DRAWINGS

FIGS. 1-4 show a prior art sound recording a playback device.

FIGS. 5-6 show a first preferred embodiment of the present invention.

FIGS. 7-9 show a second preferred embodiment of the present invention.

FIGS. 10-12 show a third preferred embodiment of the present invention.

FIG. 13 shows a fourth preferred embodiment of the present invention.

FIG. 14 shows a fifth preferred embodiment of the present invention.

FIG. 15 shows a sixth preferred embodiment of the present invention.

FIG. 16 shows a seventh preferred embodiment of the present invention.

FIG. 17 shows an eighth preferred embodiment of the present invention.

FIGS. 18-19 show a ninth preferred embodiment of the present invention.

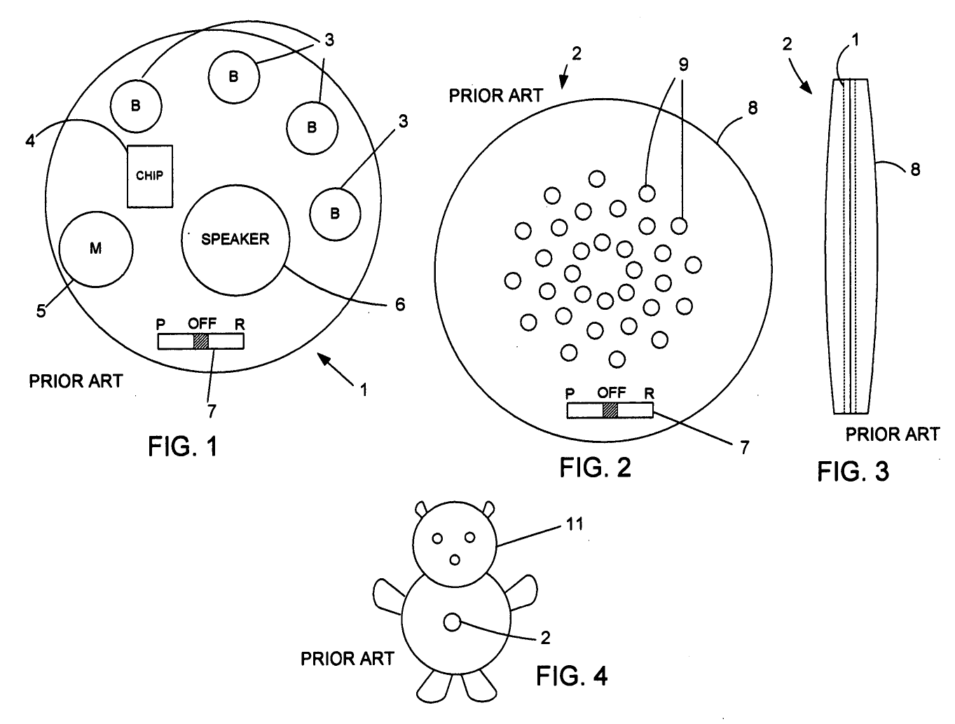

### DETAILED DESCRIPTION OF THE PREFERRED EMBODIMENTS

### First Preferred Embodiment

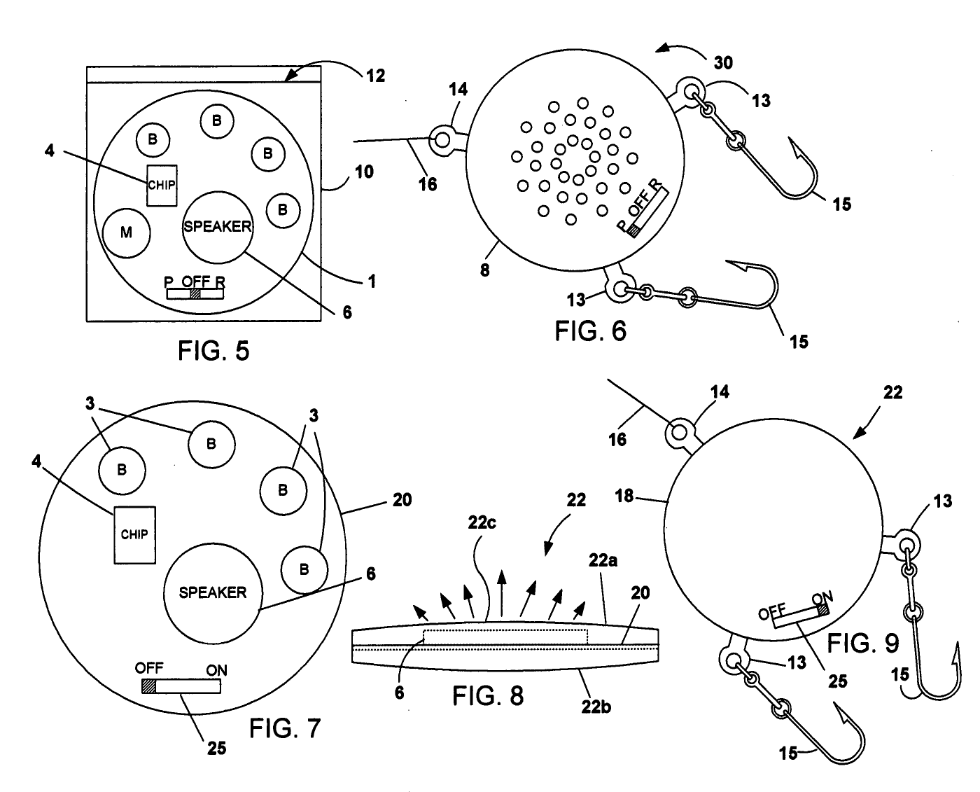

A first preferred embodiment of the present invention is shown in FIGS. 5-6. In FIG. 5, PCB 1 with record/playback integrated circuit chip 4 has been placed inside thin sealable waterproof plastic bag 10. Plastic bag 10 has then been sealed tight along seal 12. Prior to placing PCB 1 into plastic bag 10, a user recorded a 10 second recording of the sound of a pigfish grunting onto chip 4.

In FIG. 6, plastic bag 10 (FIG. 5) with PCB 1 has been placed inside casing 8 of sound lure 30. Casing 8 has been modified to include eyelets 13 and eyelet 14. Hooks 15 have been attached to eyelets 13 and line 16 has been attached to eyelet 14. Switch 7 has been moved to the play position.

### Utilization of the First Preferred Embodiment

To use the first preferred embodiment, a user merely moves switch 7 to the play position. The sound of a pigfish grunting will then be continuously repeated until batteries 4 (FIG. 1) lose their charge or until switch 7 is moved to the off position.

To catch a fish, the user throws sound lure 30 into the water. Plastic bag 10 is watertight to protect PCB 1 and its components from the water. Also, plastic bag 10 is thin enough so that the sound of the pigfish grunting emitted from speaker 6 can be heard through the plastic. The sound of the pigfish grunting will attract fish that will then be caught on hooks 15 after striking at sound lure 30.

### Second Preferred Embodiment

A second preferred embodiment is shown in FIGS. 7-9.

In the second preferred embodiment, it is not necessary for the fisherman to record onto chip 4 the sound of a pigfish grunting. Rather, the manufacturer of the lure programs the chip to produce the animal sounds. This may be done by recording and reproducing the animal sounds or the chip could be programmed to simulate the animal sounds. The recorded pigfish sound could be a recording of an actual pigfish grunting or it could be a recording of a human being imitating a pigfish grunting.

In FIG. 7, batteries 3, speaker 6, on/off switch 25 and record/playback chip 4 has been mounted onto PCB 20. Preferably, the manufacturer of sound lure 22 has prerecorded onto record/playback chip 4 a 10 second recording of a pigfish grunting. Chip 4 is programmed to automatically repeat the playing of the pigfish grunting whenever on/off switch 25 is switched to the “on” position.

In FIGS. 8-9, PCB 1 has been placed inside casing 18 of sound lure 22. Casing 18 is preferably fabricated from a corrosion resistant hard plastic. Top portion 22a of casing 18 is threaded onto bottom portion 22b to form a watertight seal. Speaker cover portion 22c is sufficiently thin so that sound emitted from speaker 6 can be heard through speaker cover portion 22c.

Casing 18 includes eyelets 13 and eyelet 14. Hooks 15 have been attached to eyelets 13 and line 16 has been attached to eyelet 14. Switch 25 has been moved to the “on” position.

### Utilization of the Second Preferred Embodiment

To use the second preferred embodiment, a user merely moves switch 25 to the “on” position. The sound of a pigfish grunting will then be continuously repeated. To catch a fish, the user throws sound lure 22 into the water. The sound of the pigfish grunting will attract fish that will then be caught on hooks 15 after striking at sound lure 22.

### Third Preferred Embodiment

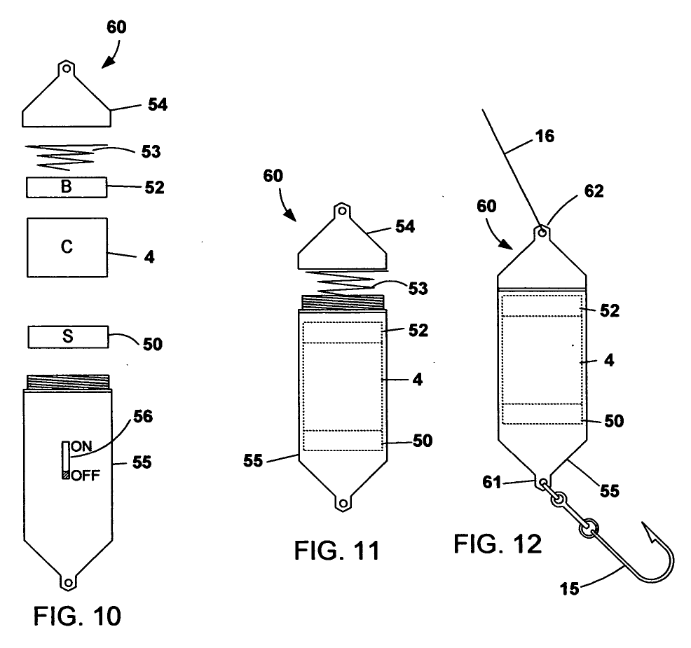

A second preferred embodiment is shown in FIGS. 10-12.

As with the second preferred embodiment, with the third preferred embodiment it is not necessary for the fisherman to record onto programmable chip 4 the sound of a pigfish grunting. Rather, this step has already been accomplished by the manufacturer. FIG. 10 shows an exploded view of the third preferred embodiment. Speaker 50, programmable chip 4 and battery 52 are placed inside bottom section 55 (see also FIG. 11). Top section 54 is then threaded onto bottom section 55. Compression spring 53 holds internal components 50, 4 and 52 in place. On/off switch 56 completes the connection between battery 52 and chip 4.

In FIG. 11, battery 52, speaker 50 and chip 4 have been placed inside bottom section 55. Preferably, the manufacturer of sound lure 60 has prerecorded onto record/playback chip 4 a 10 second recording of a pigfish grunting. Chip 4 is programmed to automatically animal the playing of the pigfish grunting whenever on/off switch 56 is switched to the “on” position.

In FIG. 12, top section 54 has been threaded onto bottom section 55 to form a watertight seal. Top section 54 and bottom section 55 are preferably fabricated from a corrosion resistant hard plastic. Bottom section 55 is sufficiently thin so that sound emitted from speaker 50 can be heard through sound lure 60.

Sound lure 60 includes eyelets 61 and 62. Hook 15 has been attached to eyelet 61 and line 16 has been attached to eyelet 62. Switch 56 has been moved to the “on” position.

### Utilization of the Third Preferred Embodiment

To use the third preferred embodiment, a user merely moves switch 56 to the “on” position. The sound of a pigfish grunting will then be continuously repeated. To catch a fish, the user throws sound lure 60 into the water. The sound of the pigfish grunting will attract fish that will then be caught on hook 15 after striking at sound lure 60.

### Fourth Preferred Embodiment

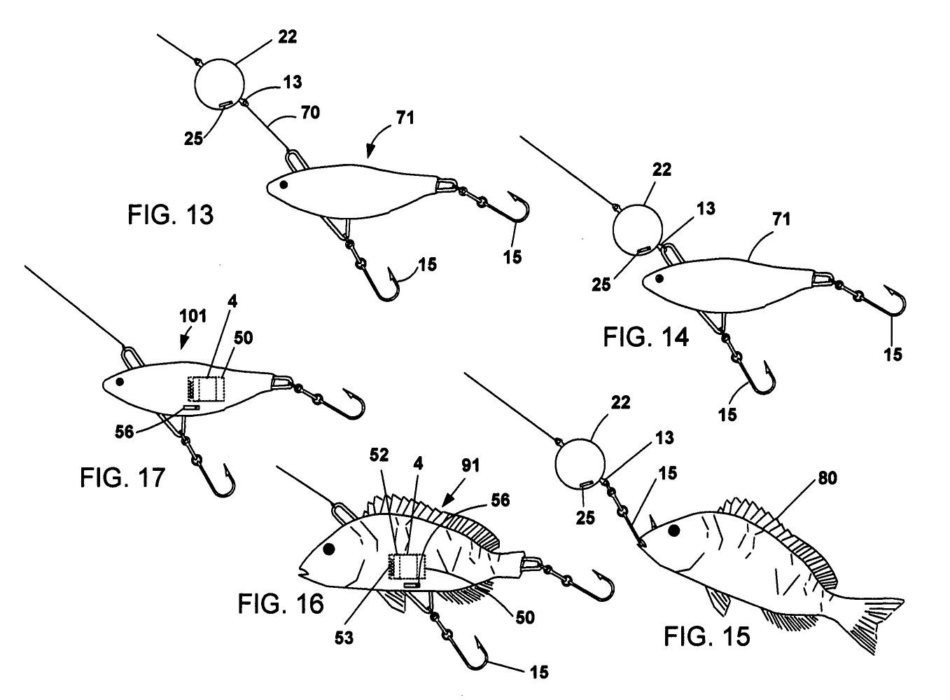

FIG. 13 shows a fourth preferred embodiment of the present invention. In the fourth preferred embodiment, sound lure 22 preferably has one eyelet 13. Line 70 connects sound lure 22 to fishing lure 71.

To use the fourth preferred embodiment, a user merely moves switch 25 to the “on” position. The sound of a pigfish grunting will then be continuously repeated.

To catch a fish, the user throws sound lure 22 into the water. The sound of the pigfish grunting and the sight of lure 71 will attract fish that will then be caught on either hook 15.

### Fifth Preferred Embodiment

FIG. 14 shows a fifth preferred embodiment of the present invention. In the fifth preferred embodiment, sound lure 22 preferably has one eyelet 13. Lure 71 is connected to sound lure 22 at eyelet 13.

As with the fourth preferred embodiment, to use the fifth preferred embodiment, a user merely moves switch 25 to the “on” position. The sound of a pigfish grunting will then be continuously repeated.

To catch a fish, the user throws sound lure 22 into the water. The sound of the pigfish grunting and the sight of lure 71 will attract fish that will then be caught on either hook 15.

### Sixth Preferred Embodiment

FIG. 15 shows a sixth preferred embodiment of the present invention. In the sixth preferred embodiment, sound lure 22 preferably has one eyelet 13. Hook 15 is connected to eyelet 13. Baitfish 80 is hooked on hook 15. Preferably, baitfish 80 is living. Also, preferably baitfish 80 is a pigfish.

As with the fourth preferred embodiment, to use the sixth preferred embodiment, a user merely moves switch 25 to the “on” position. The sound of a pigfish grunting will then be continuously repeated.

To catch a fish, the user throws sound lure 22 with baitfish 80 into the water. The sound of the pigfish grunting from sound lure 22 and the sight of baitfish 80 will attract fish that will then be caught on either hook 15. If the baitfish is a living pigfish, then it should make its own grunting noise to combine with the grunting noise from sound lure 22. The combined grunting noises will serve to attract fish. Furthermore, the sight of an actual pigfish should make attacking fish even more eager to take the bait since the noise that is being emitted from sound lure 22 is a pigfish grunting noise.

### Seventh Preferred Embodiment

FIG. 16 shows a seventh preferred embodiment of the present invention. In the seventh preferred embodiment, sound lure 91 is shaped and painted to look similar to a pigfish and serves as a waterproof encasing to internal components 50, 4, and 521. As described in reference to the third preferred embodiment, speaker 50 emits the sound of a pigfish grunting. This sound is transmitted through the side of sound lure 91 and attracts fish to the lure. On/off switch 56 is mounted to the side of sound lure 91. Hooks 15 are connected to sound lure 91.

As with the fourth preferred embodiment, to use the seventh preferred embodiment, a user merely moves switch 56 to the “on” position. The sound of a pigfish grunting will then be continuously repeated.

To catch a fish, the user throws sound lure 91 into the water. The sound of the pigfish grunting and the sight of sound lure 91 will attract fish that will then be caught on either hook 15.

### Eighth Preferred Embodiment

FIG. 17 shows an eighth preferred embodiment of the present invention. The eighth preferred embodiment is very similar to the seventh preferred embodiment, except that the eighth preferred embodiment is in the general shape of fish and is not shaped to look exactly like a pigfish. The eighth preferred embodiment recognizes that the sound lure can still be effective if it is shaped like an ordinary fish.

In the eighth preferred embodiment, internal components 50, 4, and 52 are mounted inside sound lure 101. As described in reference to the third preferred embodiment, speaker 50 emits the sound of a pigfish grunting. This sound is transmitted through the side of sound lure 101 and attracts fish to the lure. On/off switch 56 is mounted to the side of sound lure 91. Hooks 15 are connected to sound lure 91.

As with the fourth preferred embodiment, to use the seventh preferred embodiment, a user merely moves switch 56 to the “on” position. The sound of a pigfish grunting will then be continuously repeated.

To catch a fish, the user throws sound lure 101 into the water. The sound of the pigfish grunting and the sight of sound lure 101 will attract fish that will then be caught on either hook 15.

### Ninth Preferred Embodiment

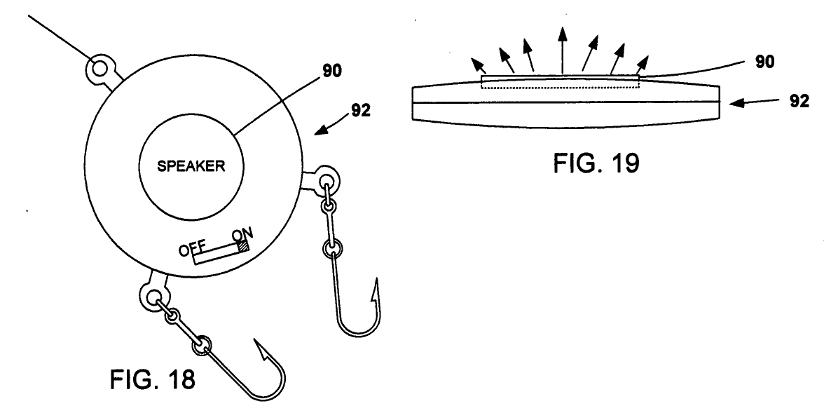

A ninth preferred embodiment is shown in FIGS. 18 and 19. The ninth preferred embodiment is similar to the earlier described embodiments with the exception that speaker 90 is an underwater speaker and is not covered completely by the casing of sound lure 92. By utilizing an underwater speaker, the sound of the pigfish grunting is louder because it does not have to travel through the casing. The underwater speaker is exposed directly to the water. By utilizing the ninth preferred embodiment, the sound will travel further and potentially attract more fish. The ninth preferred embodiment is utilized in a manner similar to that described above in reference to the earlier preferred embodiments.

### Other Preferred Embodiments

Applicant believes that the sound of a pigfish grunting attracts larger fish because a pigfish is part of the normal diet of larger fish and the pigfish naturally makes the grunting sound when disturbed. Therefore, larger fish hearing the sound may conclude that a pigfish is in trouble and may be easy prey.

In addition to the sound of a pigfish grunting, there may be sound recordings of other animals that likewise attract larger fish. For example, there are other members of the grunt family other than pigfish. For example, the porkfish (Anisotremus virginicus) is a member of the grunt family and also makes a grunting noise when disturbed. Therefore, a sound of a porkfish grunting could be used to attract a larger fish. Likewise, the Atlantic croaker (Micropogonias undulatus) is a popular baitfish for catching grouper. The Atlantic croaker makes a distinctive croaking noise by vibrating its internal air-filled swim bladder. The croaking sound is similar to a muffled booming noise. A sound lure that emits a sound of the Atlantic croaking making its noise would be useful for catching fish. Also, the sound of a seal barking could be a used to attract sharks. Sharks have excellent hearing capability and seals are part of their normal diet. Other recorded animal sounds that when played back would be useful in attracting fish include: the sound of a bullfrog, the sound of a cricket, or the sound of a mouse squeaking.

Although the above-preferred embodiments have been described with specificity, persons skilled in this art will recognize that many changes to the specific embodiments disclosed above could be made without departing from the spirit of the invention. Therefore, the attached claims and their legal equivalents should determine the scope of the invention.

What is claimed is:

1. A sound fishing lure, comprising:
A. a speaker,
B. an integrated circuit chip programmed to produce electronic signals that when transmitted to said speaker produce animal sounds, and
C. a power source for providing power to said chip.
wherein said animal sounds are heard by fish and attract said fish to said sound fishing lure.

2. The fishing lure as in claim 1, wherein said chip is programmed to record and playback said animal sounds.

3. The fishing lure as in claim 1, wherein said chip is preprogrammed to produce said electronic signals to produce said animal sounds.

4. The sound fishing lure as in claim 1, wherein said chip is further programmed to continuously repeat said transmission of said recorded animal sounds.

5. The fishing lure as in claim 1, wherein said chip is further programmed to intermittently produce said signals producing said animal sounds.

6. The sound fishing lure as in claim 1, wherein said speaker is an underwater speaker.

7. The sound fishing lure as in claim 1, wherein said power source is a battery.

8. The sound fishing lure as in claim 1, further comprising a waterproof casing for protecting said chip, said speaker and said power source.

9. The sound fishing lure as in claim 1, further comprising at least one hook connected to said sound fishing lure.

10. The sound fishing lure as in claim 1, further comprising a switch for connecting power from said power source to said chip.

11. The sound fishing lure as in claim 1, wherein said recorded animal sounds are pigfish grunting sounds.

12. The sound fishing lure as in claim 1, further comprising an artificial fishing lure connected to said sound lure.

13. The sound lure as in claim 1, further comprising at least one hook, wherein a baitfish is hooked to said at least one hook.

14. The sound lure as in claim 13, wherein said baitfish is a pigfish.

15. The sound lure as in claim 1, further comprising:
A. a fish shaped encasing for protecting said speaker, said chip and said power source, and
B. at least one hook connected to said fish shaped encasing.

16. The sound lure as in claim 15, wherein said fish shaped encasing is a pigfish shaped encasing.

17. A sound fishing lure, comprising:
A. a speaker means,
B. an integrated circuit chip means programmed to produce electronic signals that when transmitted to said speaker means produce animal sounds, and
C. a power source means for providing power to said chip means.
wherein said animal sounds are heard by fish and attract said fish to said sound fishing lure.

18. The fishing lure as in claim 17, wherein said chip means is programmed to record and playback said animal sounds.

19. The fishing lure as in claim 17, wherein said chip means is preprogrammed to produce said electronic signals to produce said animal sounds.

20. The sound fishing lure as in claim 17, wherein said chip means is further programmed to continuously repeat said transmission of said recorded animal sounds.

21. The fishing lure as in claim 17, wherein said chip means is further programmed to intermittently produce said signals producing said animal sounds.

22. The sound fishing lure as in claim 17, wherein said speaker means is an underwater speaker means.

23. The sound fishing lure as in claim 17, wherein said power source means is a battery.

24. The sound fishing lure as in claim 17, further comprising a waterproof casing means for protecting said chip means, said speaker means and said power source means.

25. The sound fishing lure as in claim 17, further comprising at least one hook means connected to said sound fishing lure.

26. The sound fishing lure as in claim 17, further comprising a switch for connecting power from said power source means to said chip means.

27. The sound fishing lure as in claim 17, wherein said recorded animal sounds are pigfish grunting sounds.

28. The sound fishing lure as in claim 17, further comprising an artificial fishing lure connected to said sound lure.

29. The sound lure as in claim 17, further comprising at least one hook, wherein a baitfish is hooked to said at least one hook.

30. The sound lure as in claim 29, wherein said baitfish is a pigfish.

31. The sound lure as in claim 17, further comprising:
A. a fish shaped encasing for protecting said speaker means, said chip means and said power source means, and
B. at least one hook connected to said fish shaped encasing.

32. The sound lure as in claim 31, wherein said fish shaped encasing is a pigfish shaped encasing.

33. A method for utilizing a sound fishing lure to catch fish, comprising the steps of:
A. connecting said sound fishing lure to a fishing line comprising a hook, wherein said sound fishing lure comprises:
1) a speaker means,
2) an integrated circuit chip programmed to produce electronic signals that when transmitted to said speaker means produce animal sounds,
3) a power source for providing power to said chip,
B. attracting said fish to said animal sounds, and
C. catching said fish on said hook.

34. The method as in claim 33, wherein said animal sounds are pigfish grunting sounds.
